(19) United States
(12) Patent Application Publication
(10) Pub. No.: US 2005/0043161 A1
(43) Pub. Date: Feb. 24, 2005

(54) Apparatuses and methods for the manufacture of metal tubular members using adhesives

(76) Inventor: Brad S. Cameron, Longmont, CO (US)

Correspondence Address: HOLLAND & HART, LLP, 555 17TH STREET, SUITE 3200, DENVER, CO, 80201, US

(21) Appl. No.: 10/643,449

(22) Filed: Aug. 18, 2003

(51) Int. Cl. B31B 1/60

(52) U.S. Cl. 493/394

(57) ABSTRACT

The present invention provides for a tubular member having a sidewall. The sidewall is arranged in a tubular configuration where an attachment lip and an attachment overlap are substantially aligned. A seal is formed between the attachment lip using an adhesive, and elastically loaded arm, and/or a mechanical fastener instead of a weld to form a closed, tubular member.

### FIELD OF THE INVENTION

The present invention relates to metal tubular members and, more particularly, to metal tubular members constructed using adhesives.

### BACKGROUND OF THE INVENTION

Metal tubular members, which are typically constructed out of steel alloys, are useful in many applications including, by way of example, construction. The process of constructing metal tubular members includes both a continuous feed method and a batch feed or non-continuous method of construction. These methods of construction are conventional and will not be explained in detail. But an overview of making metal tubular members out of steel using a continuous feed method will be described below for completeness.

First, steel is supplied to the mill in a roll or coil of material. The steel roll is paid-out off the coil as a continuous flat sheet of steel. Typically, the sheet of steel passes through a cleaner to clean the surfaces prior to manipulation of the steel. A conventional cold form-rolling machine rolls the metal sheet into a tubular shape. The edges of the rolled metal sheet are striped, joined in an abutting relationship, and welded. Finally, the tubular member is cut at a desired length making a metal tubular member having a welded seam down one side.

While a satisfactory process, the cost and time delay associated with welding the tube is significant. Thus, it would be desirous to construct a tubular member without a weld.

### SUMMARY OF THE INVENTION

To attain the advantages and in accordance with the purpose of the present invention, a metal tubular member is provided. The metal tubular member includes a sidewall formed into a tubular configuration. The sidewall has an attachment lip and an attachment overlap formed at opposing sides of sidewall. An adhesive layer is provided between the attachment lip and the attachment overlap to form a bond between the attachment lip and the attachment overlap forming the tubular member.

The present invention further provides a tubular member having a sidewall formed into a tubular configuration. The sidewall contains an attachment shoulder and an elastically loaded attachment overlap at opposing sides. The elastically loaded attachment prong engages the attachment shoulder in a sealing relationship forming the tubular member.

The present invention further provides methods of manufacturing tubular members. Manufacturing the tubular members includes the steps of forming the sheets of material into tubular configuration having a sidewall. Forming an attachment lip and an attachment overlap on opposing sides of the sidewall. Applying an adhesive layer between the attachment lip and the attachment overlap. Sealing the adhesive layer to form the tubular member.

The foregoing and other features, utilities and advantages of the invention will be apparent from the following more particular description of a preferred embodiment of the invention as illustrated in the accompanying drawings.

### BRIEF DESCRIPTION OF THE DRAWING

The accompanying drawings, which are incorporated in and constitute a part of this specification, illustrate embodiments of the present invention, and together with the description, serve to explain the principles thereof. Like items in the drawings are referred to using the same numerical reference.

FIG. 1 shows a cross sectional view of a tubular member illustrative of an embodiment of the present invention;

FIG. 2 shows the seal of FIG. 1 in more detail;

FIG. 3 shows an alternative embodiment of the seal of FIG. 1 in more detail;

FIG. 4 is a flowchart 400 illustrative of constructing the tubular member of FIG. 1;

FIG. 5 shows a cross sectional view of another tubular member illustrative of an embodiment of the present invention; and

FIG. 6 is a flowchart 600 illustrative of constructing the tubular member of FIG. 5.

### DETAILED DESCRIPTION

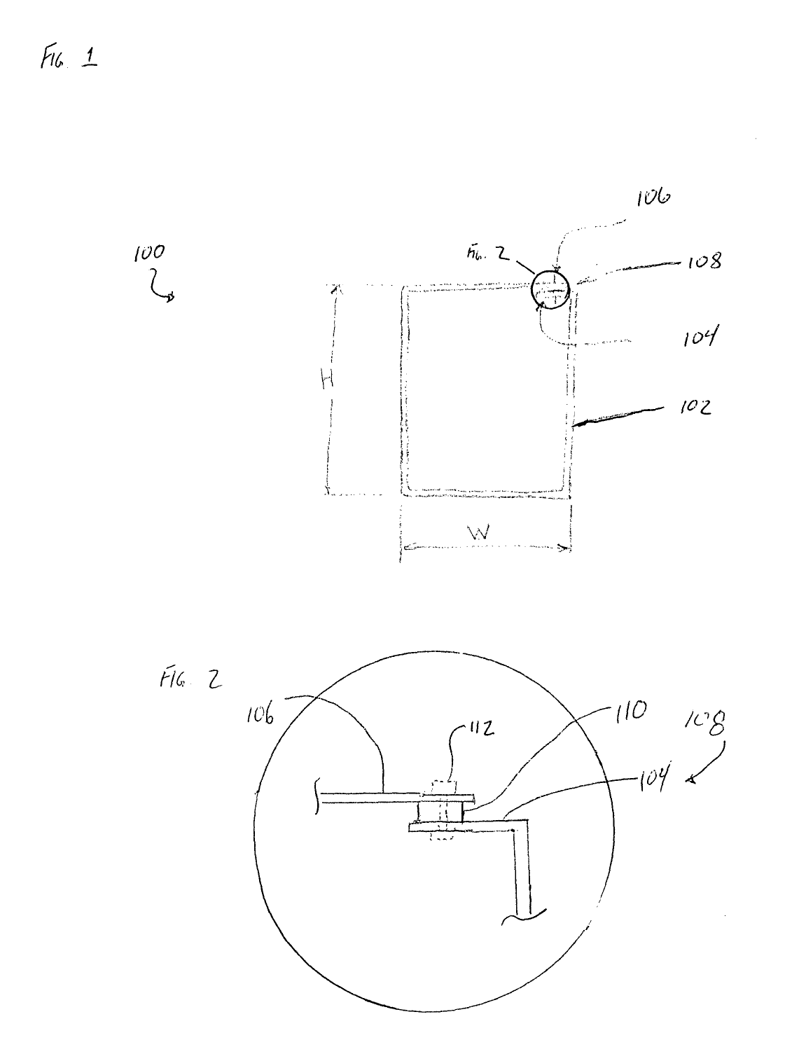

The present invention will now be described with reference to FIGS. 1 to 6. FIGS. 1 to 6 show the present invention in relation to cold-formed, steel tubes having a rectangular cross-section. One of ordinary skill in the art, on reading the disclosure, will understand other types of tube construction, other types of metals, and other shapes could be substituted. In other words, cold formed, rectangular, steel tubs is illustrative of the present invention and should not be considered limiting.

Referring first to FIG. 1, a tubular member 100 is shown. Tubular member 100 comprises a sidewall 102 formed into a rectangular tube having a width W and a height H, as shown. One of ordinary skill in the art would recognize on reading the disclosure that other shapes are possible for tubular member 100 including, without limitation, circular, oval, elliptical, polygonical, or the like. Sidewall 102 has an attachment lip 104 and an attachment overlap 106. Attachment lip 104 and attachment overlap 106 are located on opposing sides of sidewall 102. Attachment lip 104 and attachment overlap 106 are arranged such that when formed into a tubular construction, attachment lip 104 and attachment overlap 106 are substantially parallel and aligned. A seal 108 exists to close the tubular member. Seal 108 is used generically, and seal 108 does not need to be moisture proof (e.g. waterproof) or gas tight (e.g. air tight). In other words, seal 108 is a connection between attachment lip 104 and attachment overlap 106. Seal 108 is shown in more detail in FIG. 2. Seal 108 comprises an adhesive 110 between attachment lip 104 and attachment overlap 106. Adhesive 110 can be any number of adhesives including, for example, glues, tapes, epoxies, resins, acrylics, silicones, composites, and the like. Alternative to adhesive 110, mechanical fasteners 112 (shown in phantom) can form seal 108. Mechanical fasteners 112 include, for example, screws, bolts, nuts, washers, rivets, pins, nails, and the like. Adhesive 110 also could be used in conjunction with mechanical fasteners 112 as a matter of design choice.

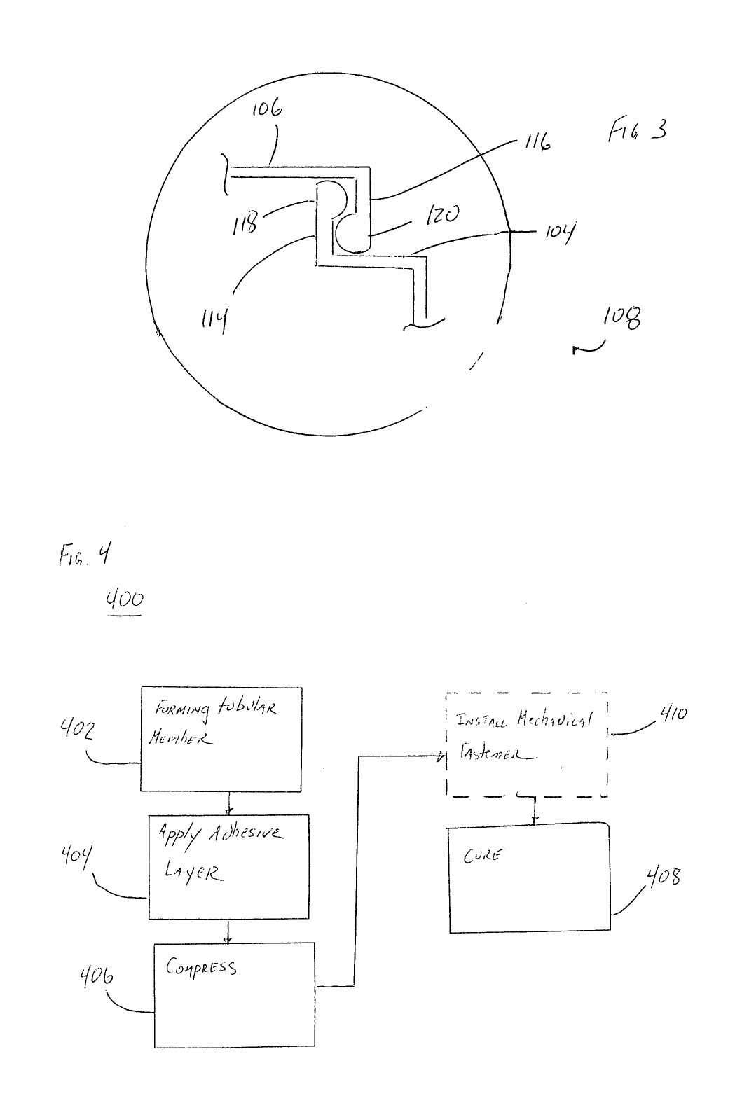

FIG. 3 shows an alternative configuration for seal 108. In this case attachment lip 104 has a first end extension 114. First end extension 114 extends from attachment lip 104 towards attachment overlap 106. Attachment overlap 106 has a second end extension 116. Second end extension 116 extends from attachment overlap 106 towards attachment lip 104. First end extension 114 comprises a first protrusion 118 and second end extension comprises a second protrusion 120. Seal 108 could also comprise an adhesive (not shown in FIG. 3, but shown in FIG. 2), and/or a mechanical fastener 112 (also not shown in FIG. 3, but shown in FIG. 2). Protrusions 118 and 120 form a snap lock or friction fitting between attachment lip 104 and attachment overlap 106. Protrusions 118 and 120 are exemplary, and other interlocking devices could be used, such as, for example, a protrusion and dimple, a lip and barb, or the like.

Referring now to FIG. 4, a flowchart 400 shows one possible method of constructing tubular member 100. First, sheet metal is formed into a tubular construction, step 402. For the rectangular tubular member shown, this includes forming sidewall 102 into a rectangular shape having a width W and a height H. A part of the formulation includes forming attachment lip 104, attachment overlap 106, and bending them to a proper, aligned orientation. Next, a bead or line of adhesive 110 is placed between attachment lip 104 and attachment overlap 106, step 404. The machine that rolls the sheet metal into the tubular configuration could automatically place adhesive layer 110 (a continuous line or intermittent dots). Alternatively, after the tube is formed, adhesive layer 110 could be manually applied. Attachment lip 104 and attachment overlap 106 are compressed together, step 406. Adhesive 110 is cured to form seal 108, step 408. Application of heat, application of electricity, application of radiation, application of pressure, or the like could cure adhesive 110. Alternatively, adhesive 110 could cure on its own over time, such as, for example, composites that may cure rapidly at normal environmental conditions.

Instead of using adhesive 110, step 408 would include installation of mechanical fasteners 112 and step 404 is removed. Alternatively, mechanical fasteners 112 could be installed before or after curing adhesive 110, step 410 (shown in phantom before step 408).

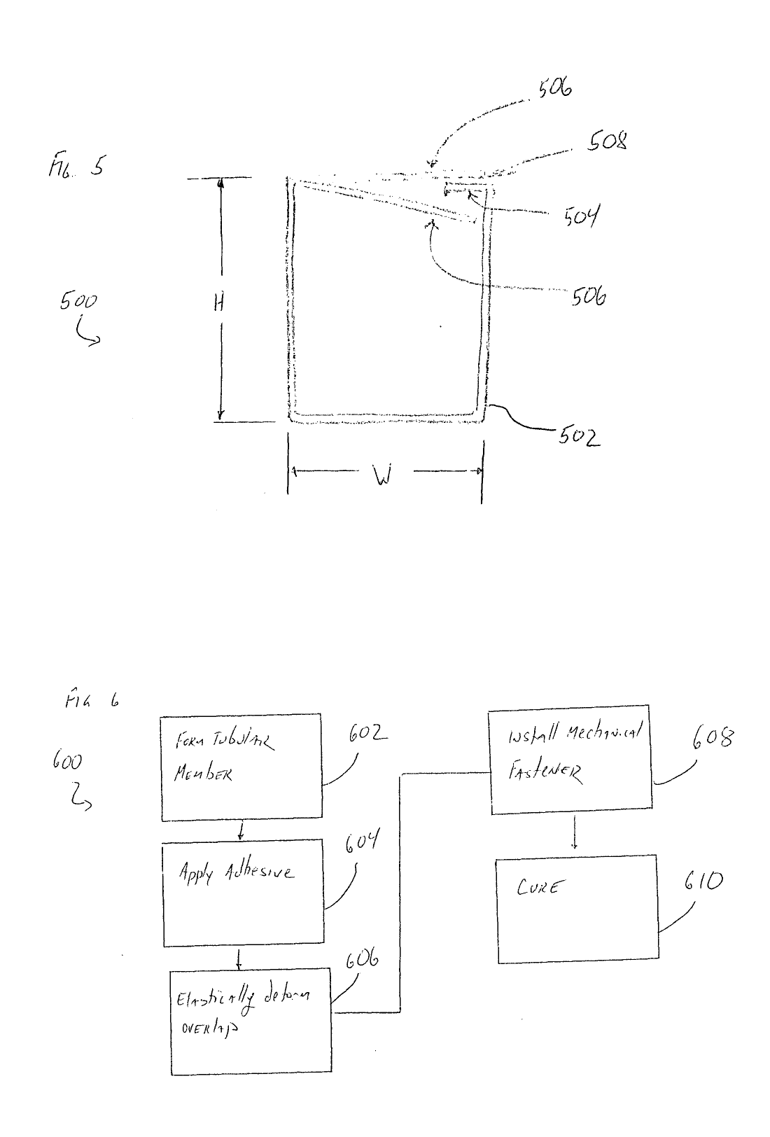

Another embodiment of the present invention is shown with reference to FIG. 5. FIG. 5 shows a tubular member 500 including a sidewall 502 bent into a tubular configuration having a width W and a height H. Sidewall 502 has an attachment lip 504 and an elastically loaded attachment overlap 506. As can be seen, elastically loaded attachment overlap 506 is shown formed at a first un-elastically deformed position.

As shown in phantom, elastically loaded attachment overlap 506 is elastically deformed into sealing relationship with attachment lip 504 to form seal 508. Seal 508 also can include an adhesive layer (not shown in FIG. 5) and/or a mechanical fastener (not shown in FIG. 5). Protrusions, such as protrusions shown in FIG. 3, could be useful in forming seal 508.

Referring now to FIG. 6, a flowchart 600 shows one possible method of constructing tubular member 500. First, sheet metal is formed into a tubular construction, step 602. For the rectangular tubular member shown, this includes forming sidewall into a rectangular shape having a width W and a height H. A part of the formulation includes forming attachment lip 504 and bending it to proper orientation. Also, elastically loaded attachment prong 506 is formed into the first, non-elastically deformed position. Optionally, a bead of adhesive is placed on attachment lip 502 or overlap 506, step 604. Next, elastically loaded attachment prong 506 is elastically deformed into a sealing relationship with attachment lip 504, step 606. Also optionally, a mechanical fastener is placed, step 608. Finally, if used, the adhesive is cured, step 610.

While the invention has been particularly shown and described with reference to an embodiment thereof, it will be understood by those skilled in the art that various other changes in the form and details may be made without departing from the spirit and scope of the invention.

1. A tubular member comprising:
a sidewall formed into a tubular configuration;
the sidewall having a first end and a second end opposed to the first end;
an attachment lip located proximate the first end;
an attachment overlap located proximate the second end;
the attachment lip substantially parallel to the attachment overlap when the sidewall is formed into the tubular configuration;
a seal to join the attachment lip and the attachment overlap in a sealing relationship such that a closed, tubular member is formed.

2. The member according to claim 1, wherein the seal comprises an adhesive layer between the attachment lip and the attachment overlap.

3. The member according to claim 2, wherein the adhesive layer is comprises of at least one of a glue, a tape, an epoxy, a resin, a silicone, and an acrylic.

4. The member according to claim 2, wherein the seal further comprises a mechanical fastener extending from the attachment overlap, through the adhesive layer, and to the attachment lip.

5. The member according to claim 4, wherein the mechanical fastener comprises at least one of a screw, a bolts, a nut, a washer, a rivet, a pin, and a nail.

6. The member according to claim 1, wherein the seal comprises a mechanical fastener extending from the attachment overlap to the attachment lip such that the attachment overlap and attachment lip are joined in a sealing relationship.

7. The member according to claim 1, wherein the seal comprises:
a first end extension on the attachment lip, the first end extension comprising a protrusion; and
a second end extension on the attachment overlap, the second end extension comprising a protrusion, wherein
the protrusions engage in a sealing relationship.

8. The member according to claim 7, wherein the seal further comprises at least one of an adhesive layer and a mechanical fastener.

9. A tubular member comprising:
a sidewall formed into a first configuration;
the sidewall having a first end and a second end opposed to the first end;
an attachment lip located proximate the first end;
an elastically loaded attachment overlap having a first position and a second position;
the elastically loaded attachment overlap being in the first position when the sidewall in configured in the first configuration;
the elastically loaded attachment overlap being elastically deformed into the second position such that the sidewall is configured in a second configuration corresponding to the shape of the tubular member;
the attachment lip and the elastically loaded attachment overlap being substantially aligned when the elastically loaded attachment overlap is in the elastically deformed second position;
the elastically deformed second position supplying a seating force to join the attachment lip and the attachment overlap in a sealing relationship such that a closed, tubular member is formed.

10. The member according to claim 9, further comprising:
an adhesive layer between the attachment lip and the elastically loaded attachment overlap when the elastically loaded attachment overlap is in the elastically deformed second position.

11. The member according to claim 9, further comprising:
a mechanical fastener extending from the attachment lip to the elastically loaded attachment overlap when the elastically loaded attachment overlap is in the elastically deformed second position.

12. The member according to claim 10, further comprising a mechanical fastener extending from the attachment lip through the adhesive layer to the elastically loaded attachment overlap.

13. The member according to claim 9, further comprising:
a first end extension coupled to the attachment lip;
the first end extension comprising a first protrusion;
a second end extension coupled to the elastically loaded attachment overlap; and
the second end extension comprising a second protrusion, wherein the first protrusion and the second protrusion engage in the sealing relationship when the elastically loaded attachment overlap is in the elastically deformed second position.

14. The member according to claim 13, further comprising at least one of an adhesive layer and a mechanical fastener.

15. A tubular member comprising:
a sidewall formed into a tubular configuration;
the sidewall having a first end and a second end opposed to the first end;
an attachment lip located proximate the first end;
an attachment overlap located proximate the second end;
the attachment lip substantially parallel to the attachment overlap when the sidewall is formed into the tubular configuration;
means for sealing the attachment lip and the attachment overlap in a seal relationship to form a closed, tubular member.

16. A method of constructing a tubular member, the method comprising the steps of:
forming a tubular member such that the tubular member has an attachment lip and an attachment overlap substantially aligned;
placing an adhesive layer such that the adhesive layer resides between the attachment lip and the attachment mechanism; and
curing the adhesive layer such that a seal is formed joining the attachment lip and the attachment overlap in a sealing relationship wherein a tubular member is formed.

17. The method according to claim 16, wherein the step of placing the adhesive layer places a continuous adhesive layer.

18. The method according to claim 16, wherein the step of placing the adhesive layer places a noncontiguous adhesive layer.

19. The method according to claim 16, wherein the step of placing the adhesive layer is accomplished at part of forming the tubular member.

20. The method according to claim 16, further comprising the step of applying pressure to the attachment lip and the attachment overlap such that the adhesive layer is compressed.

21. The method according to claim 16, further comprising the step of installing a mechanical fastener that extends from the attachment lip through the adhesive layer to the attachment overlap.

22. A method of constructing a tubular member, the method comprising the steps of:
forming a tubular member such that the tubular member has an attachment lip and an elastically loaded attachment overlap, and the tubular member is in a first configuration where the elastically loaded attachment overlap is in a first position not elastically deformed; and
elastically deforming the elastically loaded attachment overlap until the tubular member is in a second configuration where the elastically loaded attachment overlap is substantially aligned with the attachment lip.

23. The method according to claim 22, further comprising the steps of:
applying an adhesive between the elastically loaded attachment overlap and the attachment lip; and
curing the adhesive.

24. The method according to claim 23, further comprising the step of installing a mechanical fastener.

25. The method according to claim 22, further comprising the step of installing a mechanical fastener.
